(19) United States
(12) Patent Application Publication
(10) Pub. No.: US 2004/0243622 A1
(43) Pub. Date: Dec. 2, 2004

(54) Data sorting apparatus and method

(75) Inventor: Shuichi Morisawa, Saitama (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/851,108

(22) Filed: May 24, 2004

(30) Foreign Application Priority Data
May 29, 2003 (JP) 2003-152835

(51) Int. Cl. G06F 17/00

(52) U.S. Cl. 707/102

(57) ABSTRACT

Data sorting apparatus and method for sorting data into categories. According to the data sorting apparatus and method of the present invention, when data movement between categories is designated, a message in accordance with a category-belonging state of the data is outputted. By virtue of this invention, for instance in a case where a document is sorted into plural categories, it is possible to prevent unclear relations of belongingness between the categories after the document icon is dragged from one category to another category.

### FIELD OF THE INVENTION

The present invention relates to a data sorting apparatus and method for sorting data, such as documents or the like, into categories.

### BACKGROUND OF THE INVENTION

In a data sorting system for sorting inputted data into categories, it is normally impossible to think that the sorted result outputted by the system is 100% correct. Therefore, it is assumed that there are a lot of data that have been sorted into categories that are inappropriate in user's view. Such data that have erroneously been sorted by the system is again sorted into user-desired categories by manual operation, and this change in sorting is analyzed by the system to readjust respective parameters of a sorting dictionary and to reflect the change so that the system is trained to correctly sort the next input data. This training is called system learning.

Each time sorting is executed, the user examines the sorted result, and if the user thinks the data is erroneously sorted, the user provides the data with a correct category to make the system learn. By repeating this operation, it is believed that the system will eventually be able to perform sorting that is close to user's intention. Japanese Patent Application Laid-Open (KOKAI) No. 2003-91542, which is one of the conventional art related to system learning, discloses an algorithm concerning learning.

As an example of data, described herein is a case of sorting a document. A general method for designating a correct category of an erroneously sorted document is to drag an icon representing the document to an icon representing a correct category by a mouse. This operation fits in well with the merit of the graphic user interface (GUI) in the Window system. This operation is advantageous because it gives a user an intuitive image of document's movement between categories as if a book shelved in the wrong category is returned to a bookshelf of a correct category.

However, sorting data differs from sorting books in the following points. Each book has only one predetermined library classification. However when document data is sorted, one document data may be sorted into plural categories for user's convenience, or there may be plural category sets. This causes confusion in operation.

Assuming that documents that belong to a certain category are displayed, and one of the documents is selected by a user and moved to a different category. But if in fact the selected document has already belonged to this category, it is difficult for a user to intuitively figure out what kind of relations of belongingness the document should have with respect to these categories.

### SUMMARY OF THE INVENTION

The present invention has been proposed to solve the above-described and other problems. More specifically, according to the data sorting apparatus and method of the present invention, in a case where a document is sorted into plural categories and an icon representing the document is dragged from one category to another category, unclear relations of belongingness between the categories can be prevented.

For instance, documents that belong to a certain category are displayed, and one of the documents is selected by a user and moved to a different category. But if in fact the selected document has already belonged to this category, it is difficult for a user to intuitively figure out what kind of relations of belongingness the document should have with respect to these categories. To prevent such situation, the data sorting apparatus and method according to the present invention outputs a message before moving the document to clarify the priority rank of the categories after the operation.

Furthermore, according to the data sorting apparatus and method of the present invention, in a system having plural category sets, if a user tries to move a document, which are sorted into plural categories of different category sets, from one category to another category of a different category set, a message is outputted to have the user recognize the current category of interest, thereby preventing confusion and erroneous operation in advance.

In order to realize the above objects, more specifically, the data sorting apparatus according to the present invention comprises means for designating movement of data between categories, and means for outputting a message in accordance with a category-belonging state of the data in a case where data movement between categories is designated.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a construction of functions of a data sorting apparatus according to an embodiment of the present invention;

FIG. 2 is a diagram showing a construction of a sorted result display unit;

FIG. 3 is a block diagram showing a hardware construction of the data sorting apparatus according to an embodiment of the present invention;

FIG. 4 is a flowchart showing a learning process flow according to the present invention;

FIG. 5 is a flowchart showing a sorting process flow according to the present invention;

FIG. 6 shows an example of a cooccurrence probability between words;

FIG. 7 shows an example of an effective-word dictionary;

FIG. 8 shows an example of a weight dictionary using a positional role of an effective word as an evaluation item;

FIG. 9 is a flowchart showing same-category-set processing;

FIG. 10 shows an example where a list of categories is displayed on a display window of the present invention;

FIG. 11 shows an example of a category definition file;

FIG. 12 shows an example of a sorted result file having a document ID as an index;

FIG. 13 shows a screen example in which a category is selected on the display window;

FIG. 14 shows a screen example in which a document is selected on the display window;

FIG. 15 shows a screen example in which the learning process is started for user determination on a sorted result;

FIG. 16 is a flowchart showing a learning process flow of user determination on a sorted result;

FIG. 17 shows a screen example of a confirmation window which is displayed in response to user operation for changing a sorting destination of a document that belongs to one category;

FIG. 18 shows a screen example of a confirmation window which is displayed in response to user operation for changing a sorting destination of a document that belongs to plural categories;

FIG. 19 shows a screen example of a confirmation window which is displayed in response to user operation for changing a sorting destination of a document that belongs to plural categories;

FIG. 20 shows a screen example of a selection window which is displayed in response to user operation for changing a sorting destination of a document that belongs to plural categories;

FIG. 21 shows a screen example of a warning window which is displayed in response to user operation for changing a sorting destination to a different category set;

FIG. 22 shows a screen example of a warning window which is displayed in response to user operation for changing a sorting destination to a different category set;

FIG. 23 shows a screen example in which a category set of interest is changed to a category set B after the sorting destination is changed; and

FIG. 24 is a flowchart showing a message output flow.

### DETAILED DESCRIPTION OF THE PREFERRED EMBODIMENTS

Preferred embodiments of the present invention will now be described in detail in accordance with the accompanying drawings.

Hereinafter, a data sorting apparatus according to an embodiment of the present invention is described in detail. As an example of data, a document is handled in this embodiment. As a matter of course, the present invention is also applicable to data other than a document.

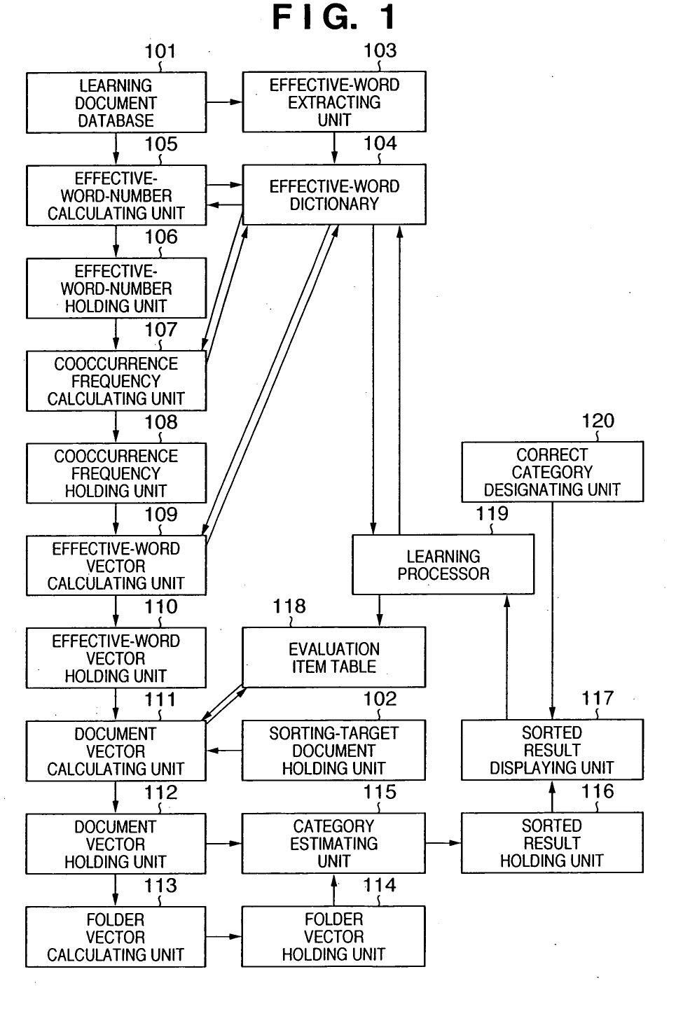

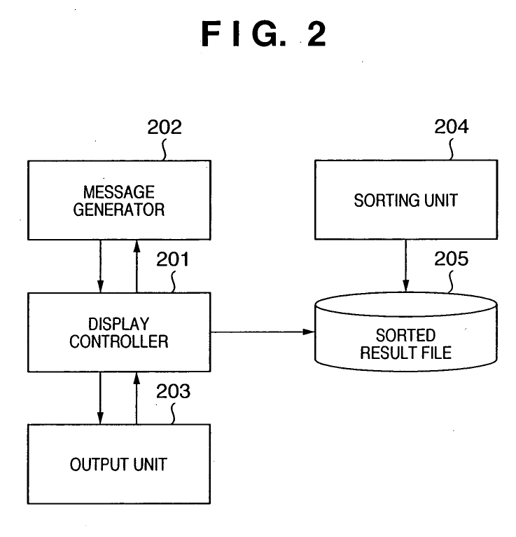

FIG. 1 is a diagram showing a construction of functions of the data sorting apparatus according to this embodiment. FIG. 2 is a diagram showing a detailed construction of a sorted result display unit 117 included in the construction shown in FIG. 1. As will be described later, a message generator 202 shown in FIG. 2 is the most important component of the present invention. A result of sorting performed by a sorting unit 204 is stored as a sorted result file 205. A display controller 201 outputs a sorted state to an output unit 203 by referring to the sorted result file 205. The display controller 201 also outputs a message generated by the message generator 202 to the output unit 203.

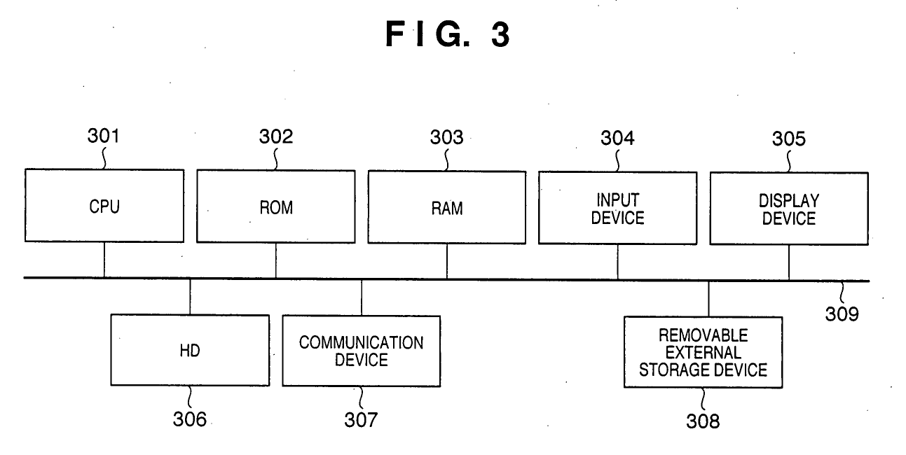

FIG. 3 is a block diagram showing a hardware construction of the data sorting apparatus according to this embodiment.

In the construction shown in FIG. 3, a CPU 301 is a microprocessor which performs calculations for document sorting, logical determination and so forth, and controls via a bus the respective components connected to the bus. The bus 309 transfers control signals and address signals for designating the respective components subjected to control by the CPU 301. The bus 309 also performs data transfer among respective components.

RAM 303 is a writable random access memory which serves as a primary memory of various data transmitted by respective components. ROM 302 is a read-only fixed memory and stores a boot program for the CPU 301. The boot program is a control program which is stored in the hard disk, loaded to the RAM at the time of system start-up, and executed by the CPU 301.

An input device 304 is a keyboard, a mouse or the like. A display device 305 is a CRT, a liquid crystal display or the like. A HD 306 is a hard disk which stores control programs or the like executed by the CPU 301. A removable external storage device 308 is a drive for accessing an external storage device, e.g., a floppy disk, CD, DVD and so on. The removable external storage device 308 can be used similarly to the HD 306, and can perform data exchange with other document processing apparatus through these recording media. Note that the control programs stored in the hard disk can be copied from these external storage devices to the HD 306 if necessary.

A communication device 307 is a network controller which performs data exchange with an external unit via a communication line. The document sorting apparatus according to the present invention, which comprises the above-described components, operates in accordance with various inputs from the input device. When an input is supplied from the input device, first an interruption signal is transmitted to the CPU 301. Based on the signal, the CPU 301 reads various commands stored in the ROM or RAM and executes the commands, thereby performing various controls.

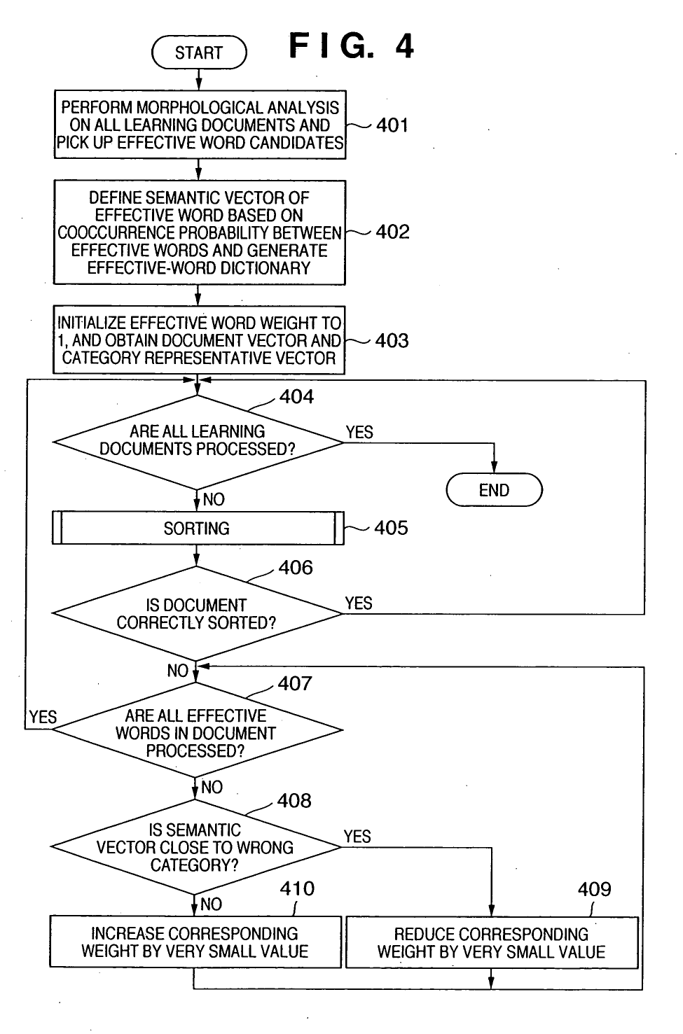

FIG. 4 is a flowchart showing a learning process in the data sorting apparatus according to the present embodiment. In the learning process, a learning document where a sorting destination is designated by a user in advance is analyzed, and a dictionary necessary to perform sorting is generated. First, the learning document is subjected to morphological analysis to cut sentences into words. Then, a common noun, a proper noun, and an unknown word that is not found in a morphemic dictionary are picked up. Only the words having a relatively high total frequency of appearance in the entire learning document and having a high reliability are selected and the rest is discarded. Among the selected words, only the words that heavily appear in a particular category are nominated as the effective word candidates. For this reason, a localized level is calculated for each of the picked up words. Among the learning documents that belong to the category Cj, a ratio of documents including the word Wi is defined as Pij. In other words, the number of documents that belong to the category Cj and include Wi is divided by the number of documents that belong to the category Cj. Note, for any words, it is normalized that the total values of the localized levels for all categories become 1. In other words, assuming that categories are C1, C2, . . . , Cm, Σ(j=1, m)Pij=1 is satisfied. The localized level E(Wi) of the word Wi with respect to the category Cj is defined by the following:

E(Wi)=1+Σ(j=1, m)Pij*log m Pij

N number of words are selected in descending order of the localized level value, and the selected words are nominated as effective word candidates (process 401 in the flowchart in FIG. 4).

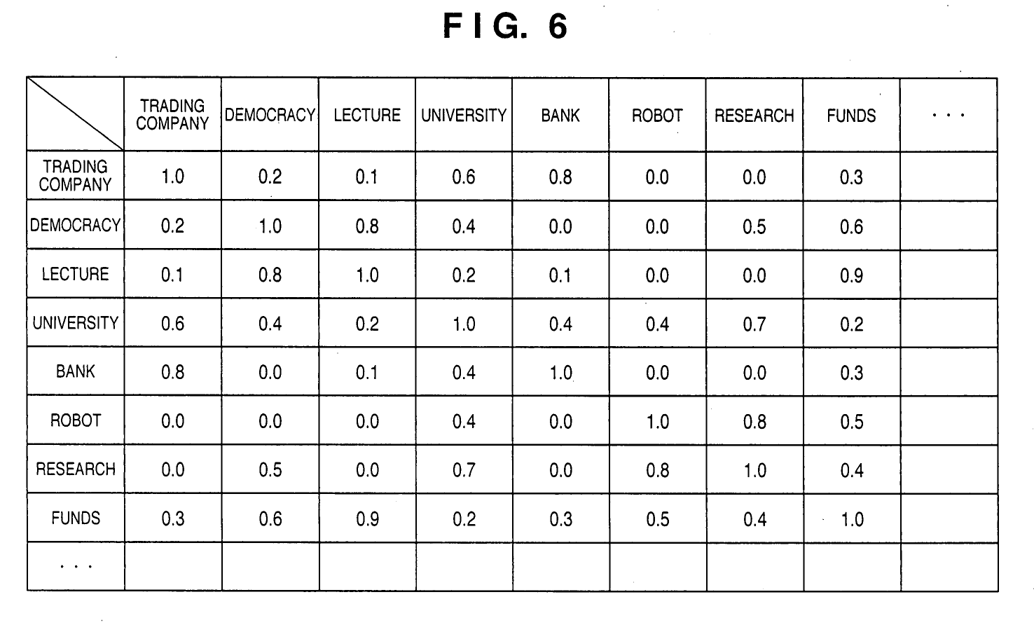

Next, in order to obtain a distance between words, a vector value called a semantic vector is defined for each effective word. An axis of the vector is all the effective words, and a component value of the vector is a cooccurrence probability between an effective word of interest and all the effective words serving as the axis of the vector. Note that the cooccurrence probability of the word Wi with respect to the word Wj is defined by the ratio of the number of documents including both Wi and Wj to the number of documents including Wi. According to FIG. 6 showing a cooccurrence probability, for instance, the vector expression of the word “trading company” is (1.0 0.2 0.1 0.6 0.8 0.0 0.0 0.3 . . . ).

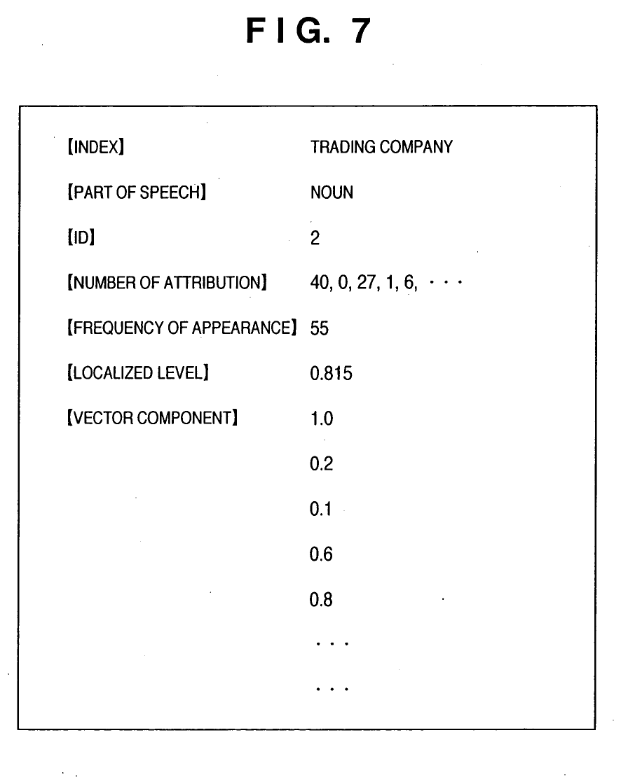

Based on these data, an effective-word dictionary is generated (process 402 in the flowchart in FIG. 4). FIG. 7 shows an example of the effective-word dictionary having the word “trading company as an index. The number of attribution is the number of documents including this word, shown in units of category. The number of appearance is the total number of learning documents including this word.

After the effective-word dictionary is generated, a vector of each learning document can be defined by calculating a weighted average of the semantic vectors of the effective words included in the learning document. Moreover, a representative vector of each category is defined by calculating an average of vectors of all the learning documents that belong to the category (process 403 in the flowchart in FIG. 4).

The weight of the effective word is defined in consideration of the following two perspectives: how effective the effective word is for the act of sorting; and how important the position the effective word holds in each document. The first perspective shows the level of attribution to each category. The higher the level of distinguishing a particular category, the heavier the weight added to the effective word. Therefore, the aforementioned localized level is employed. The second perspective evaluates how the effective word is used in the document and how the effective word is related to the subject matter of the document. For this evaluation, evaluation items are generated in advance in view of an appearance position of the effective word, a case role of the effective word, and a linguistic role such as a modification type. Then, a weight value to be added in a case where the effective word satisfies the condition of each evaluation item is defined by repetition of learning shown in the processes 404 to 410 of the flowchart in FIG. 4. When the learning starts, the weight is initialized to 1.

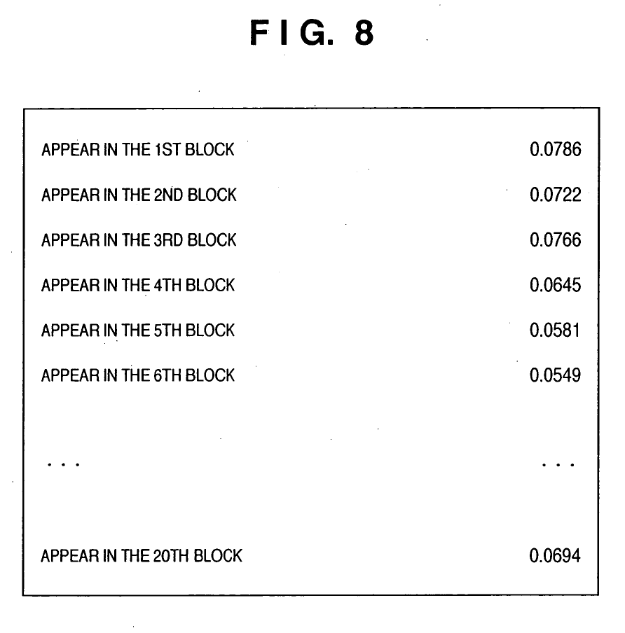

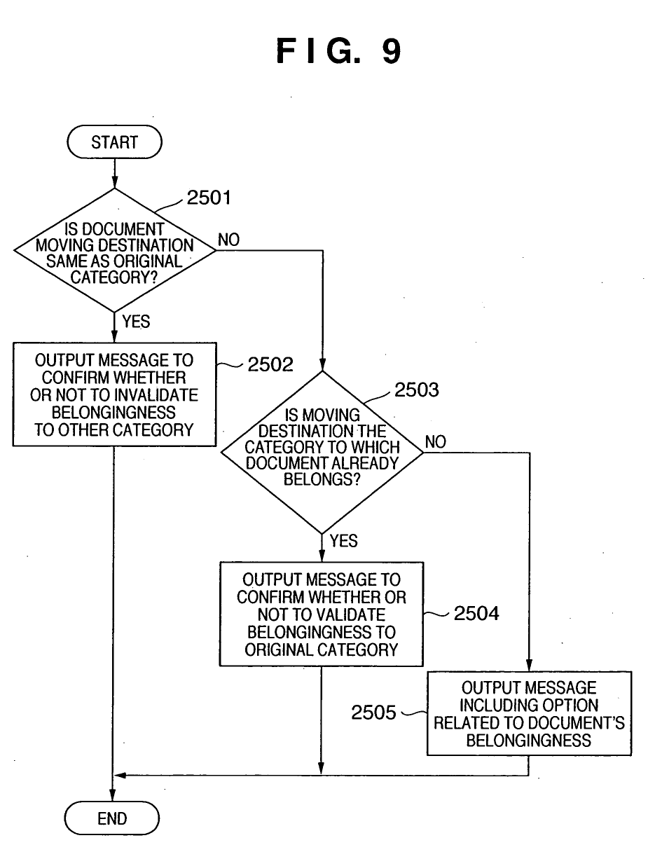

The weight based on the second perspective is stored in a dictionary using the value of each evaluation item, and the dictionary is referred to at the time of sorting along with the effective-word dictionary storing the weight based on the first perspective, i.e., the localized level of the effective word, so that the total weight of each effective word is calculated. FIG. 8 shows an example of a weight dictionary storing weight values, using an appearing position of an effective word as an evaluation item. FIG. 9 shows an example of a weight dictionary using a linguistic role of an effective word as an evaluation item.

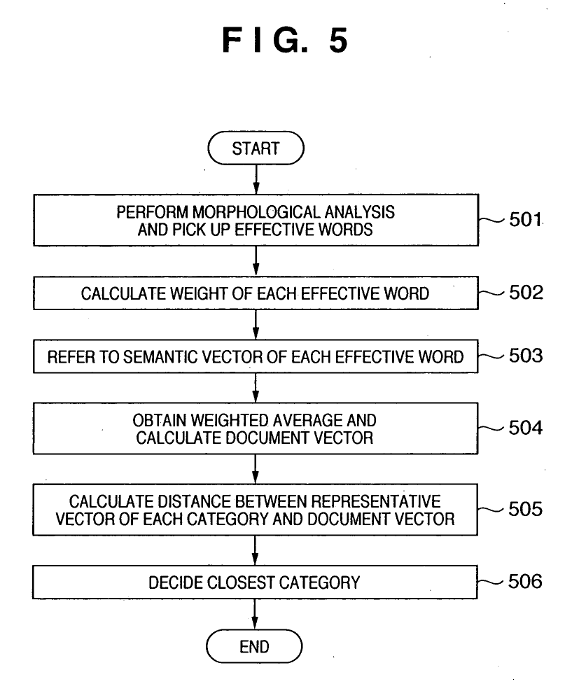

Next, the aforementioned learning of the weight is described. Sorting is performed on each of the learning documents by referring to the effective-word dictionary, category representative vector, and weight dictionary having current weight values that have been generated above. Then, the weight value for each evaluation item is slightly adjusted, and sorting is performed again. This process is repeated to determine the final weight value (processes 404 to 405 in the flowchart in FIG. 4). FIG. 5 is a flowchart describing a sorting process.

As has been performed in the beginning of the learning process, the sorting-target document is again subjected to morphological analysis, and effective words included in the document is picked up by referring to the effective-word dictionary (process 501 in the flowchart in FIG. 5). Note that FIG. 5 describes the process for sorting a document other than a learning document after the learning process of the weight is completed. Therefore, in a case of sorting in the weight learning process as described herein, needless to say the morphological analysis does not have to be executed again, but the result of the morphological analysis executed in the beginning of the learning process can be stored and used as the process result herein.

Next, the weight of the picked up effective word is calculated (process 502 in the flowchart in FIG. 5). The weight value based on the first perspective is obtained from the localized level stored in the effective-word dictionary, and the weight value based on the second perspective is obtained with reference to the two weight dictionaries shown in FIGS. 8 and 9. By gathering these values, the total weight is obtained.

Next, the semantic vector is acquired from the effective-word dictionary (process 503 in the flowchart in FIG. 5). The above processes are performed with respect to all effective words picked up from the sorting-target document. Then, the weight calculated in the process 502 is added to the semantic vector of each effective word, an average of the weighted semantic vectors is obtained, and a document vector of the sorting-target document is obtained (process 504 in the flowchart in FIG. 5).

Then, a distance between the representative vector of each category obtained in the process 503 in FIG. 5 and the document vector of the sorting-target document is calculated (process 505 in the flowchart in FIG. 5). The distance between two vectors is obtained from a cosine value of an angle formed with two vectors, which is obtained by calculating an inner product, as commonly performed. A category-having the closest distance is decided as the sorting-destination category for the sorting-target document (process 506 in the flowchart in FIG. 5).

Sorting in the process 405 in the flowchart in FIG. 4 is performed in the above-describe manner. Now, the description on the weight learning process is continued referring back to the process 406 in FIG. 4.

In the learning document, a correct category desired by the user is determined in advance. Therefore, the sorting-destination category obtained in the process 405 is compared with the correct category. If these categories match, there is no need to perform tuning on the weight and no more processing is required for this learning document. Therefore, the control proceeds to processing of the next learning document in the loop 404. If these categories do not match, the sorting-destination category outputted by the sorting system is considered wrong, and the weight value in the weight dictionary is adjusted in the following manner. With respect to each effective word included in the learning document, the semantic vector acquired in the process 503 is referred, and a distance between the semantic vector and the correct category as well as a distance between the semantic vector and the sorting-destination category obtained in the process 405 are respectively calculated to determine whether the semantic vector of the effective word is closer to the representative vector of the correct category or the representative vector of the sorting-destination category (process 408 in the flowchart in FIG. 4). If the semantic vector of the effective word is closer to the sorting-destination category, in order to bring the document vector of this document closer to the correct category, the two weight dictionaries are corrected so that the weight value of the weight evaluation item corresponding to the effective word of interest is reduced by a very small value (process 409 in the flowchart in FIG. 4). On the contrary, if the semantic vector of the effective word is closer to the correct category, it is considered that the weight evaluation item corresponding to the effective word contributes to the correct sorting. Therefore, the weight dictionaries are corrected to increase the weight value by a very small value (process 410 in the flowchart in FIG. 4). This processing is performed on all the effective words picked up from the learning document (loop 407 in FIG. 4) to adjust the weight values.

The above-described processes are repeated regarding all the learning documents subjected to sorting (loop 404 in the flowchart in FIG. 4). The processes are repeated a number of times for the series of learning documents until the weight values are most appropriate, and the weight dictionary is finally completed. In the foregoing manner, the learning process is completed.

A general document other than a learning document is sorted with reference to the various dictionaries generated in the foregoing manner. The procedure of sorting a general document is identical to the procedure described in the weight learning process. The only difference is in that the learning document has a given correct category and a general document has an unknown category.

Note although the process 506 in the flowchart in FIG. 5 determines and outputs only one sorting-destination category of the sorting-target document, there may be a case by coincidence that the distance of the category's representative vector is the same as the distance of the document vector of the sorting-target document and that there are plural categories for the sorting-target document. Furthermore, some system may require to output plural sorting-destination categories. In the latter case, a predetermined threshold value is given to a distance between the category's representative vector and the document vector of the sorting-target document, and for instance, plural categories exceeding the predetermined threshold value are outputted as the sorting-destination categories.

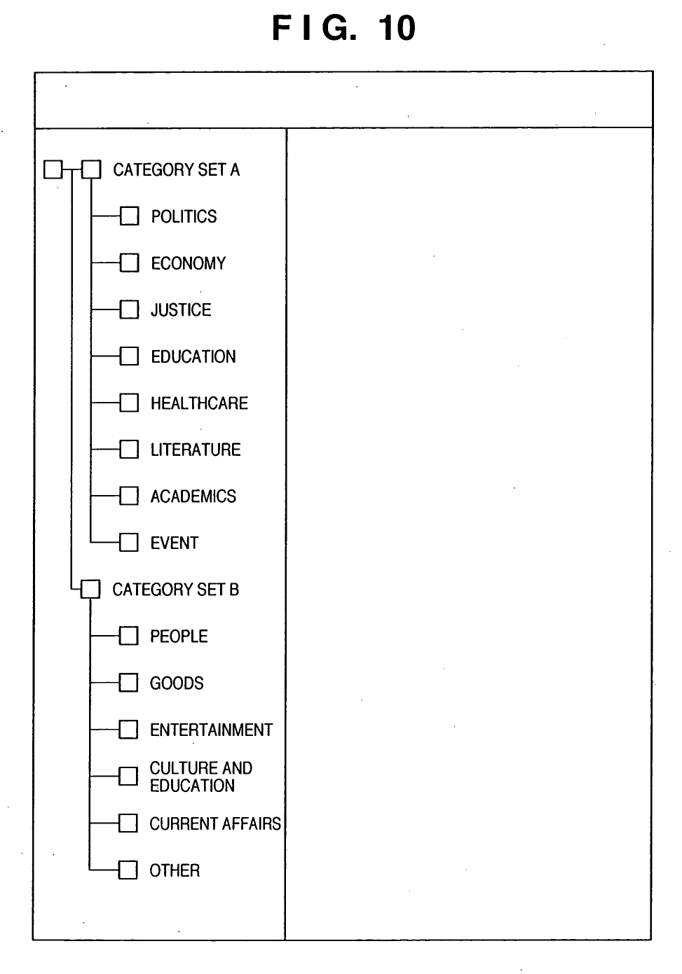

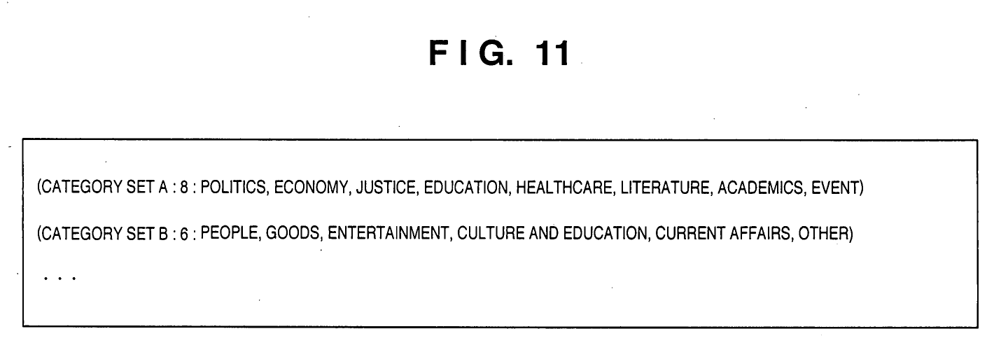

Next, a method of displaying the sorted result is described. FIG. 10 shows an example where categories, defined by a system administrator or a system end user on the automatic document sorting system, are displayed on the left side of the display window according to the present invention. FIG. 11 shows an example of a category definition file, which is an example of a system file storing categories and contents of the category set defined by the administrator of the automatic document sorting system. Each entry consists of a group of three values: a category set ID, the number of categories defined in the category set, and a list of categories defined in the category set.

There are cases that one sorting system is shared by plural end users and that documents are sorted into category sets that are different for each user. In this case, the system includes plural numbers of category sets. Therefore, names such as category set A, category set B and so on are given to distinguish each category set. In the category set A, eight categories are defined: “politics,” “economy,” “justice,” “education, “healthcare,” “literature,” “academics,” and “event.” In the category set B, six categories are defined: “people,” “goods,” “entertainment,” “culture and education,” “current affairs,” and “other.”

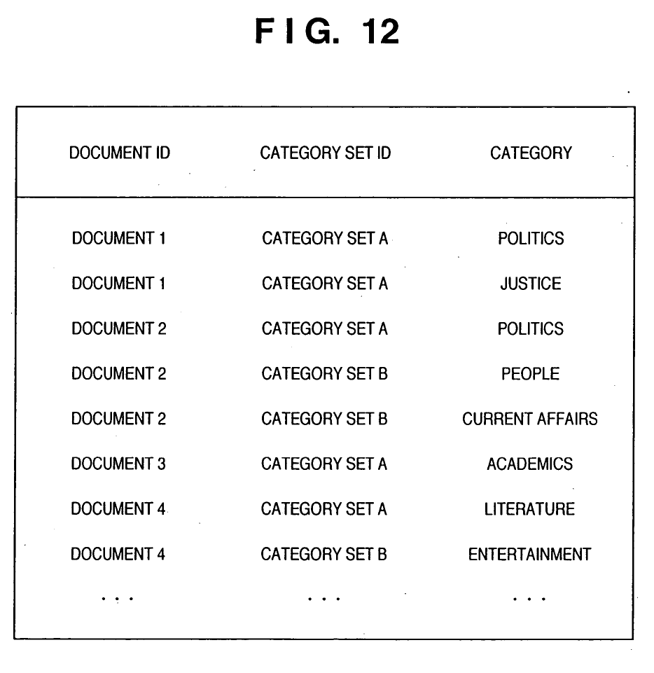

FIG. 12 shows an example of a sorted result file. The file describes a category set and a category of each document that has been subjected to automatic sorting by the system. The file is updated each time sorting is performed on a sorting-target document. Each entry is expressed with a group having three attributes: a “document ID” for uniquely identifying a document stored in the system, a “category set ID” for specifying an ID of the category set of interest, and a “category” for identifying a category in the category set.

When a user selects an arbitrary category in FIG. 10 using a mouse or a keyboard, the display controller 201 refers to the sorted result file 205 in FIG. 12 to search for entries having the same category attribute as that of the selected category, and the document ID of the entry searched is acquired to display the title of the document.

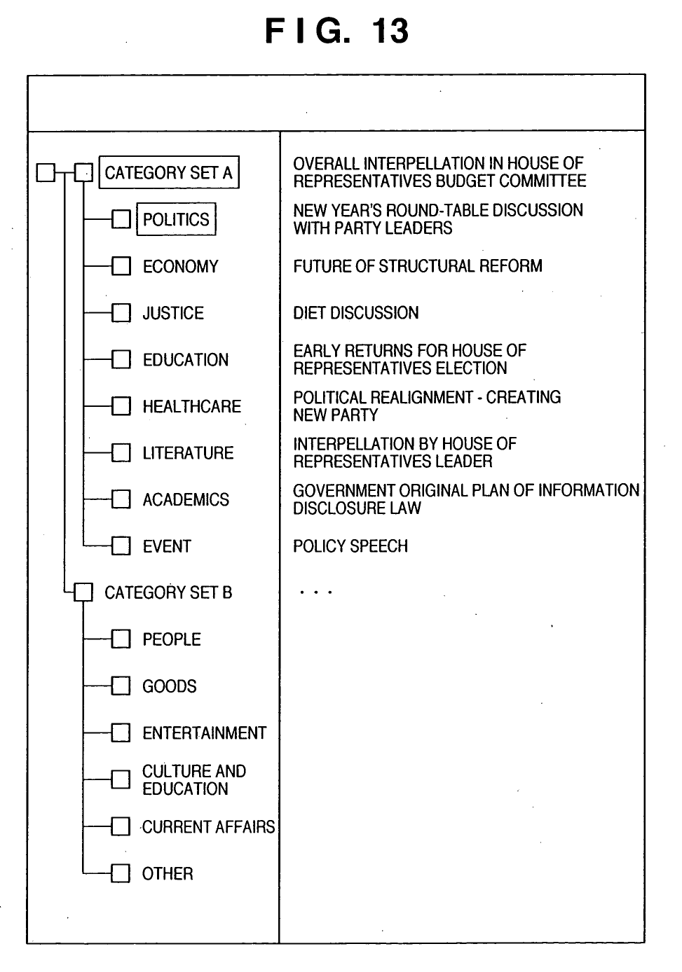

FIG. 13 shows an example of the screen displayed at this time. In this example, the category “politics” in the category set A is selected from the list of categories shown in FIG. 10. The right side of the window shows a list of documents that have been sorted into the category selected on the left side of the window. In this example, titles of all the documents that belong to the category “politics” are displayed.

Next, an arbitrary document is selected by a mouse or a keyboard from the list of document titles displayed on the right window in FIG. 13. The display controller 201 refers to the sorted result file 205 in FIG. 12 to search for all entries having the same document ID as that of the selected document, and a pair of category set attribute and category attribute of the entries is acquired. In the list of categories displayed on the right window, only the categories corresponding to the acquired pair are highlighted.

In a conventional automatic document sorting system, it is possible to display a list of documents corresponding to a selected category. However, in reverse, when a document is selected, since the conventional system does not search the sorted result file shown in FIG. 12 based on the selected document, it is impossible to display all categories to which the selected document belongs. However, since the present invention provides the document sorted result file which stores corresponding relations between categories and documents that belong to each category for all category sets, and enables search based on either a selected category or a selected document, it is not only possible to refer to all the documents corresponding to the selected category, but also possible to perform operation in reverse, i.e., refer to all the categories corresponding to the selected document.

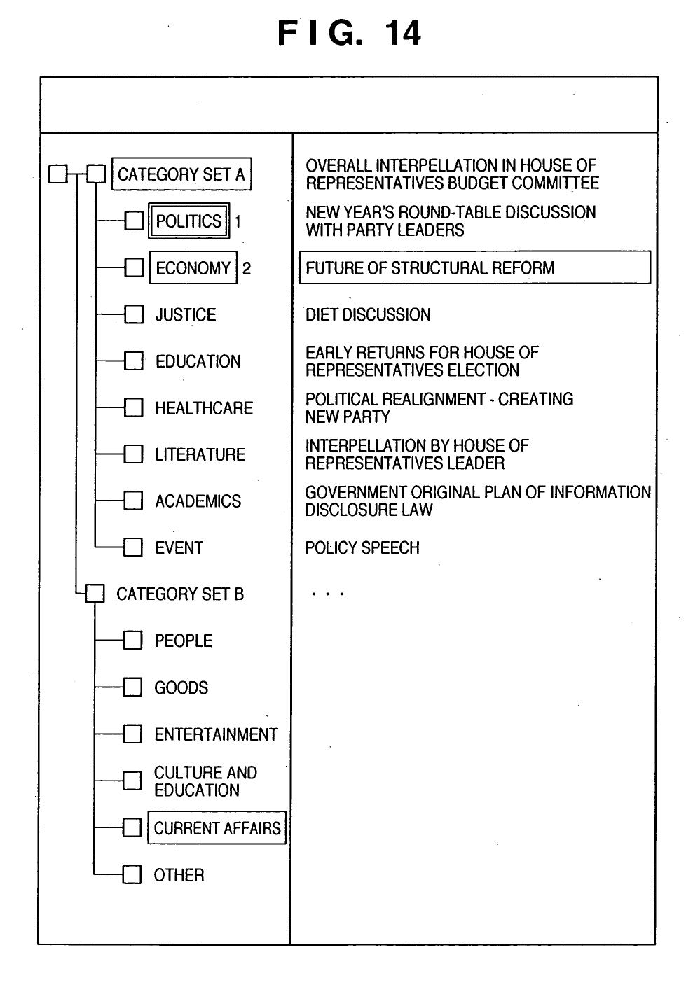

FIG. 14 shows an example of a screen at this time. When a document titled “future of structural reform” is selected from a list of documents, in correspondence the category into which the document is sorted is highlighted in the left window. Since this document is sorted into two categories “politics” and “economy” in the category set A and one category “current affairs” in the category set B, the three categories are highlighted. Note that the category of interest “politics” in the category set A should be distinctively displayed to be distinguished from other two categories, so that it is clear where the list of documents displayed on the right window belongs to. Therefore, the category “politics” is displayed in a color different from other two categories or displayed with an underline to be distinguished from other categories.

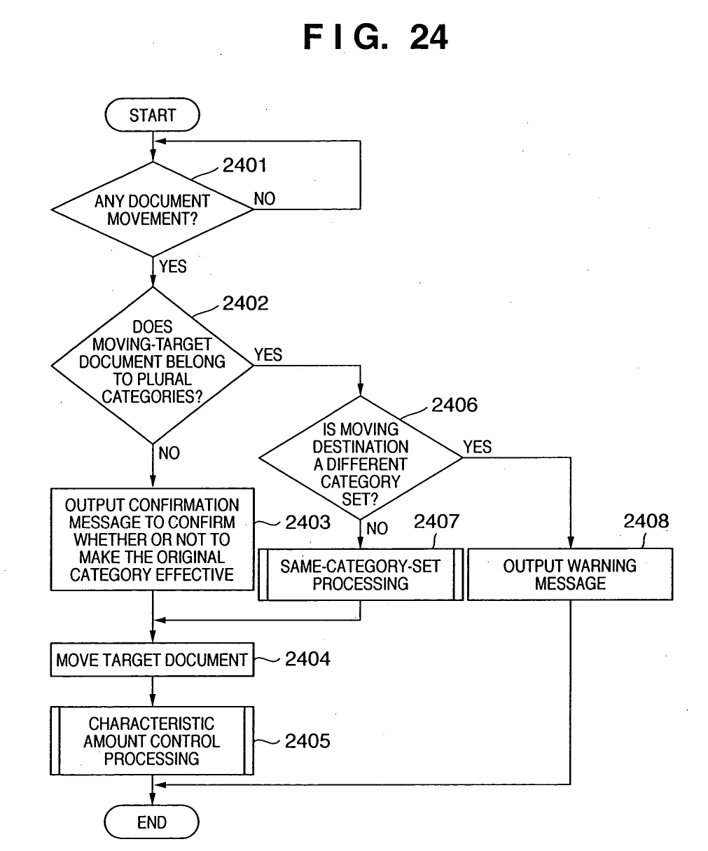

The sorted result of documents is displayed in the foregoing manner. The user examines the result to determine whether the categories decided by the system is correct or incorrect for the user, and if necessary designates a correct category for the user to make the system learn. Next, correcting the sorted result to make the system learn is described with reference to the flowchart in FIG. 24.

In S2401, whether or not a document has been moved is monitored. If a document is moved, the control proceeds to S2402. In S2402, it is determined whether the moving-target document belongs to plural categories. If the target document belongs to a single category, the control proceeds to S2403, whereas if the target document belongs to plural categories, the control proceeds to S2406.

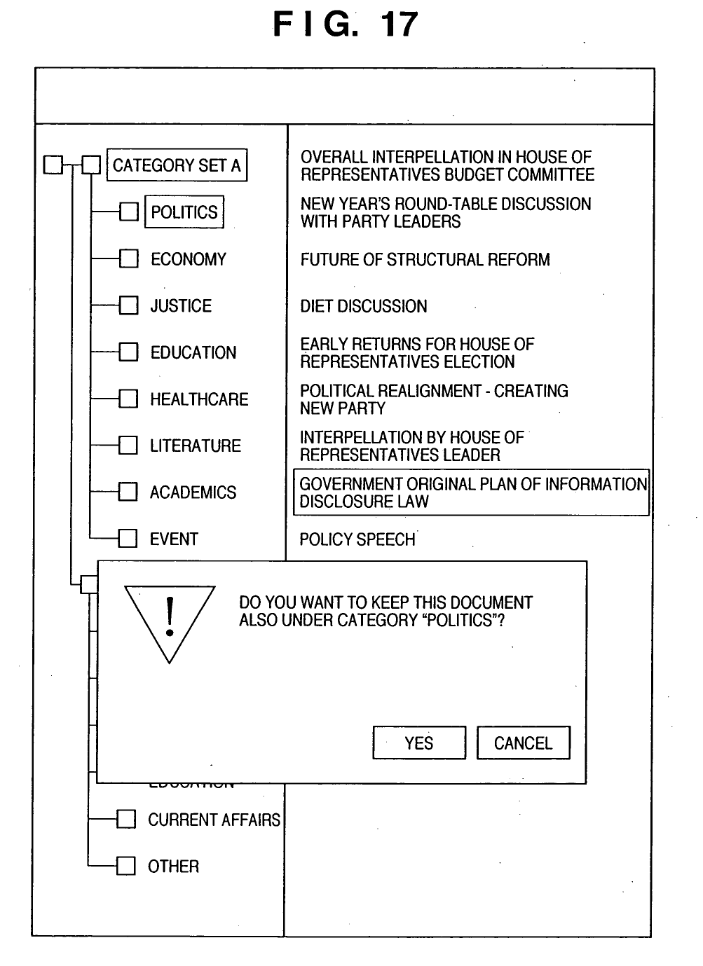

An example where the target document belongs to a single category is described with reference to FIG. 17. In FIG. 17, the category “politics” in the category set A is the category of interest, and a list of documents that belong to the category “politics” is shown on the right window. Assume that a user is not satisfied that the document titled “government original plan of information disclosure law” is sorted into the category “politics” and that the user wants to sort this document into the category “justice.” The user drags this document to the category “justice” in the left window by a mouse. In this stage, the system is unable to decide whether this document should also be kept under the category “politics” or deleted from the “politics.” Therefore, a confirmation message as shown in FIG. 17 is outputted before moving the document (S2403). If “YES” is selected, the document's belonging to the category “politics” remains and the document belongs to both categories “politics” and “justice” after the document is moved. If “NO” is selected, the document's belonging to the category “politics” is deleted and the document belongs to the category “justice” only. When the moving-target document belongs to only one category as in this case, it is relatively easy to understand the relations of belongingness. Therefore, an embodiment may be constructed such that when a user drags a document from the category “politics” to “justice,” no confirmation message is displayed and the document is deleted from the category “politics” and belongs to the category “justice” only.

In S2406, it is determined whether or not the moving destination is a different category set. If the moving destination is the same category set, the control proceeds to S2407 for the same-category-set processing (FIG. 9). If the moving destination is a different category set, the control proceeds to S2408.

An example where the document is moved to the same category set is described. In FIG. 14, the category “politics” in the category set A in the left window is the category of interest, and a list of document titles sorted into the category of interest “politics” is shown in the right window. Among them, the selected document “future of structural reform” belongs to the categories “politics” and “economy” in the category set A and the category “current affairs” in the category set B. In sorting in the category set A, the category “politics” has a higher likelihood than the category “economy.”

Herein although the likelihood rank is shown in numerals 1, 2, . . . , it is better to adopt a visually comprehensible display method, for example, changing a display color.

Herein, the same-category-set processing is described with reference to the flowchart in FIG. 9. In S2501, it is determined whether or not the document moving destination is the same category as the original category. If it is the same, the control proceeds to S2502, whereas if it is not the same, the control proceeds to S2503.

The case where the document moving destination is the same category as the original category is described hereinafter. In this example, a user is not satisfied that the document is sorted into the category “economy” and the user wants to sort the document into only one category “politics.” When the category “politics” is the category of interest and a list of documents that belong to the category “politics” is shown in the right window as in FIG. 14, the document-of interest is dragged with a mouse to the category “politics” in the left window.

In this operation, the document of interest is intentionally moved to the category “politics” to which the document already belongs with the first-rank likelihood. This operation realizes the user's intention to invalidate the belongingness of this document to other categories and have this document belong to only one category “politics.”

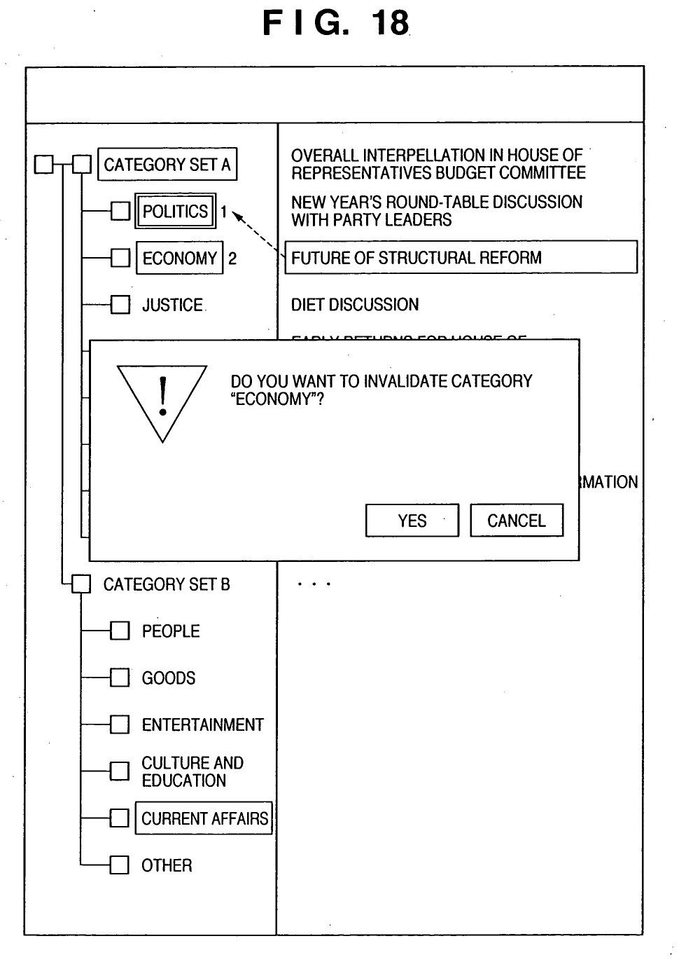

In order to make sure that the document movement to the category “politics” to which the document already belongs with the first-rank likelihood is not user's erroneous operation and that the belongingness to the category “economy” to which the document belongs with the second-rank likelihood should be deleted, a, confirmation message shown in FIG. 18 is displayed before moving the document (S2502). Note that the dotted line with an arrow in FIG. 18 is shown to indicate that dragging of the document icon to the category icon is performed immediately before the confirmation message window is displayed. Therefore, in reality the dotted line with an arrow is not necessarily displayed on the screen.

In S2503, it is determined whether or not the moving destination is the category to which the document already belongs. If the moving destination is the category to which the document already belongs, the control proceeds to S2504, whereas if the moving destination is a category to which the document does not belong, the control proceeds to S2505.

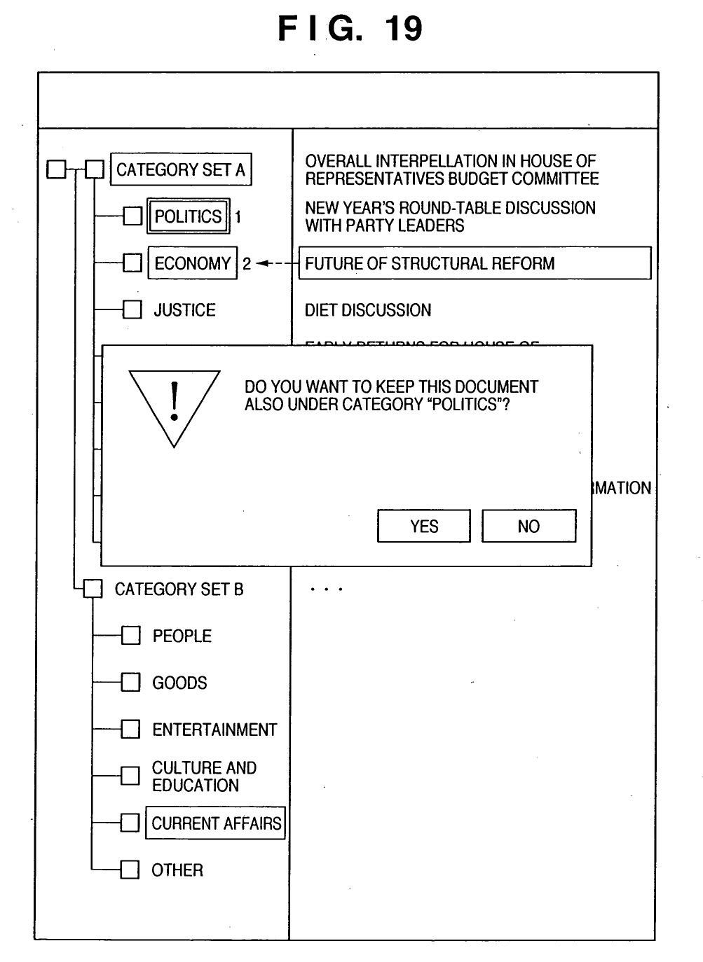

A description is provided on the case of moving the document to the category to which the document belongs. First, the selected document in FIG. 14 is dragged to the category “economy.” This operation is performed to realize the user's intention to prioritize the category “economy” as the first priority rank. However, the system is unable to decide whether or not the belongingness of this document to the category “politics” should also be maintained. In other words, it is unclear whether the document should be sorted into the category “economy” only or two categories with the first priority in “economy” and the second priority in “politics.” Therefore, a confirmation message shown in FIG. 19 is displayed (S2504). If the user wants to keep the document under the category “politics” with the second rank priority, “yes” button is selected, whereas if the user wants to sort the document into the category “economy” only, “no” button is selected.

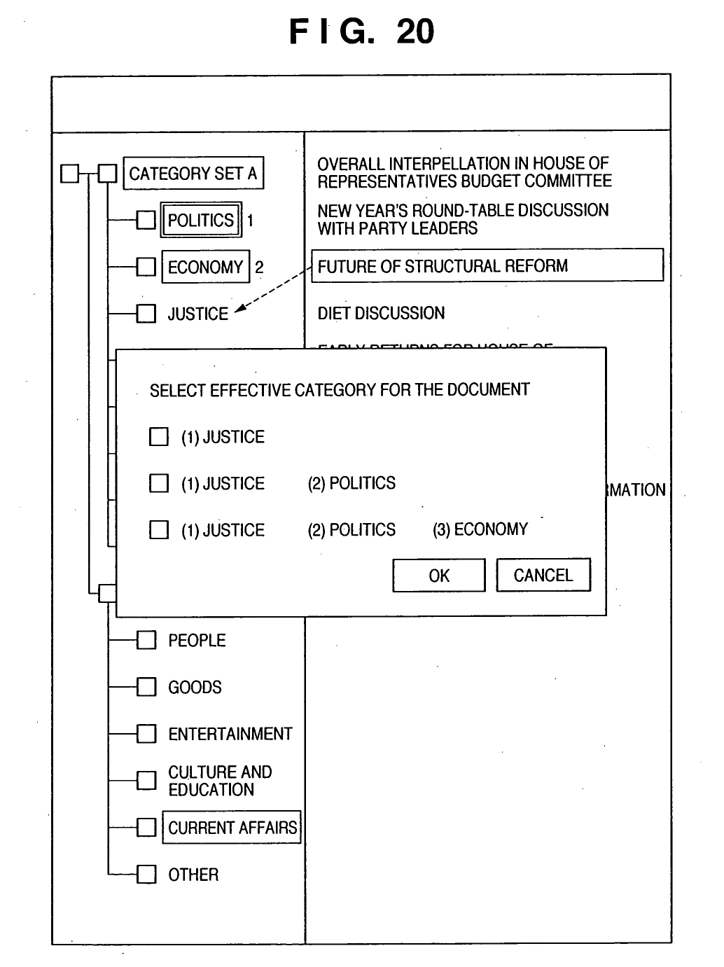

Next, a description is provided on a case of moving the document to a category to which the document does not belong. More specifically, the selected document is dragged from the state shown in FIG. 14 to the category “justice.” The category “justice” is not currently a sorting-destination category of the selected document. The document dragging operation indicates that the user is not satisfied that the document is sorted into “politics” and “economy,” and the user selects “justice” as the most appropriate category. Also in this case, it is unclear whether or not to maintain the belongingness to the categories “politics” and “economy” after the category is changed to “justice.” In order to confirm the user whether the categories “politics” and “economy” should be validated as the second rank and the third rank, a message including three sorting-destination patterns as shown in FIG. 20 is outputted (S2505) to have the user select one. The three options are: sort the document into “justice” only; sort the document into “justice” as the first rank and “politics” as the second rank; or sort the document into “justice” as the first rank, “politics” as the second rank and “economy” as the third rank.

If the user wants to sort the document into “economy” as the second rank and “politics” as the third rank, the document should first be dragged to the category “economy” before dragging to the category “justice,” and the “yes” button is selected in the confirmation window in FIG. 19 to change the “economy” and “politics” to the first and second sorting destinations respectively. Then, the document of interest is dragged to the category “justice” and selection is made in the selection window shown in FIG. 20. In this manner, the document is sorted in order of “justice,” “economy,” and “politics.” As a matter of course, other methods such as directly designating the category's priority ranks using the right click of a mouse or the like, are possible.

In the foregoing manner, a message based on the document's category-belonging state and the document's moving destination is outputted and actual document moving is performed in S2404 in accordance with the selection.

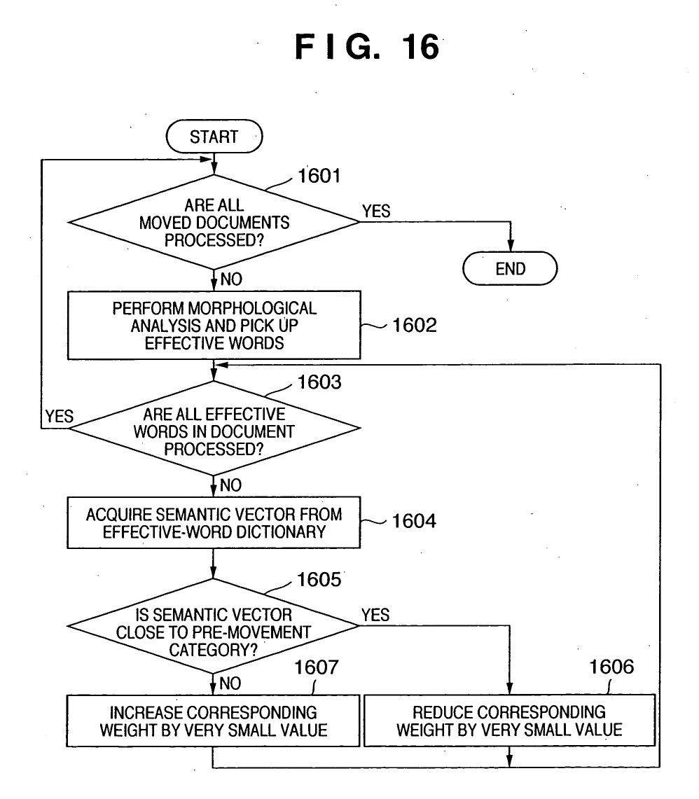

In S2405, a characteristic amount of the document and category is controlled. Details of this control is described in FIG. 16. The moving-target document is subjected to morphological analysis, and effective words included in the document are picked up with reference to the effective-word dictionary (process 1602 in the flowchart in FIG. 16). A semantic vector of each effective word is acquired from the effective-word dictionary (process 1604 in the flowchart in FIG. 16). A representative vector of the category to which the document has belonged before the document is moved (hereinafter referred to as the pre-movement category) and a representative vector of the category to which the document belongs after the document is moved (hereinafter referred to as the-post-movement category) are acquired from the dictionary which stores representative vectors for each category. A distance between the semantic vector of the effective word and the representative vector of the pre-movement category as well as a distance between the semantic vector of the effective word and the representative vector of the post-movement category are calculated. Then, it is determined whether the semantic vector of the effective word is closer to the representative vector of the pre-movement category or the representative vector of the post-movement category (process 1605 in the flowchart in FIG. 16). If the semantic vector of the effective word is closer to the representative vector of the pre-movement category, in order to bring the document vector of this document closer to the representative vector of the post-movement category, the two weight dictionaries are corrected so that the weight value of the weight evaluation item corresponding to the effective word of interest is reduced by a very small value (process 1606 in the flowchart in FIG. 16). On the contrary, if the semantic vector of the effective word is closer to the representative vector of the post-movement category, it is considered that the weight evaluation item corresponding to the effective word contributes to the correct sorting. Therefore, the weight dictionaries are corrected to increase the weight value by a very small value (process 1607 in the flowchart in FIG. 16).

This processing is performed on all the effective words picked up from the document (loop 1603 in the flowchart in FIG. 16) to adjust the weight values.

Then, the above-described processes are repeated for all the documents that have been moved (loop 1601 in the flowchart in FIG. 16), and the learning process is completed.

In the above description, documents are moved between categories within one category set. However, in a case where a user has an authority to carry out maintenance of plural category sets and a case where categories of plural category sets are simultaneously displayed in the right window, there may be a risk that the user erroneously moves a document to a category set that is different from the category set of interest.

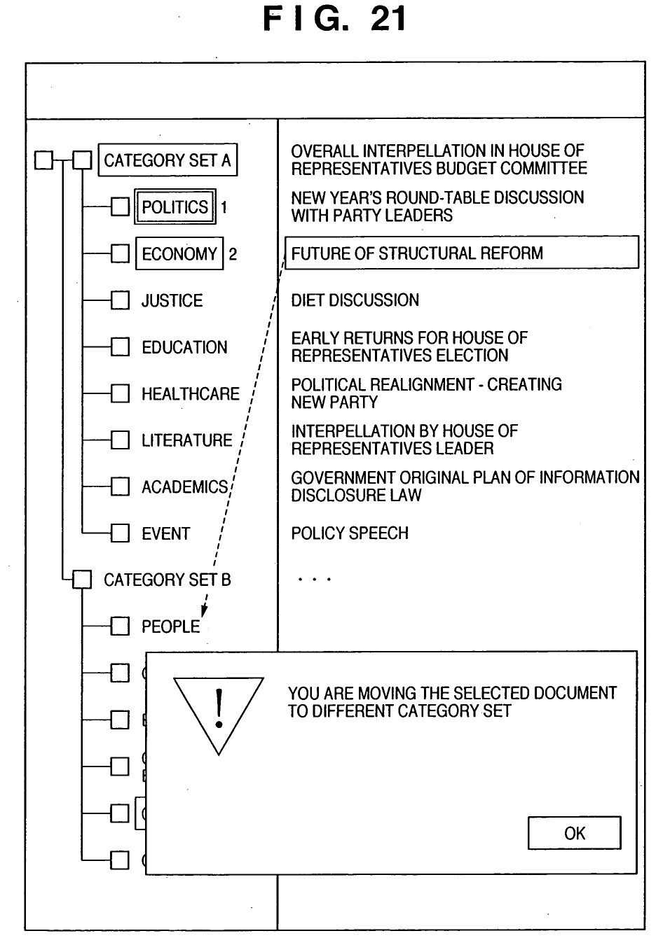

For instance, assume that a user who administrates two category sets A and B attempts to drag a document of interest in the category set A to another category in the category set B. In this case, since the user operation may be erroneous operation, a warning message shown in FIG. 21 is outputted to call user's attention.

Then, the process in the flowchart in FIG. 24 ends.

### Second Embodiment

In the example shown in FIG. 21, the category set A is the category set of interest, the category “politics” is the category of interest, and a list of document titles that belong to the category of interest is shown in the right window. In the first embodiment, when the user attempts to move the document “future of structural reform” to the category “people” in the category set B, the system determines that it is user's erroneous operation because “people” does not belong to the category set of interest, and a warning message is displayed.

For another embodiment, there may be a case that a user, who is fully familiar with the category set B and contents thereof, wants to move a document of interest from the category “current affairs” to people” within the category set B, while the category of interest is fixed to the current state, i.e., category set A. The system intended for such user may be designed so that, when a user moves a document in a category set outside the category set of interest as shown in FIG. 21, a message is displayed to notify that the document sorted in the category “current affairs” is moved to “people” and the document movement is executed upon user's concurrence.

Note that the state of sorting in the category set A does not change after this operation is performed. Therefore, the document of interest “future of structural reform” remains in the category “politics” as the first priority rank and in the category “economy” as the second priority rank.

Furthermore, the second embodiment may be constructed such that a message according to the situation is outputted at the time of moving a document between categories, as in the first embodiment.

### Third Embodiment

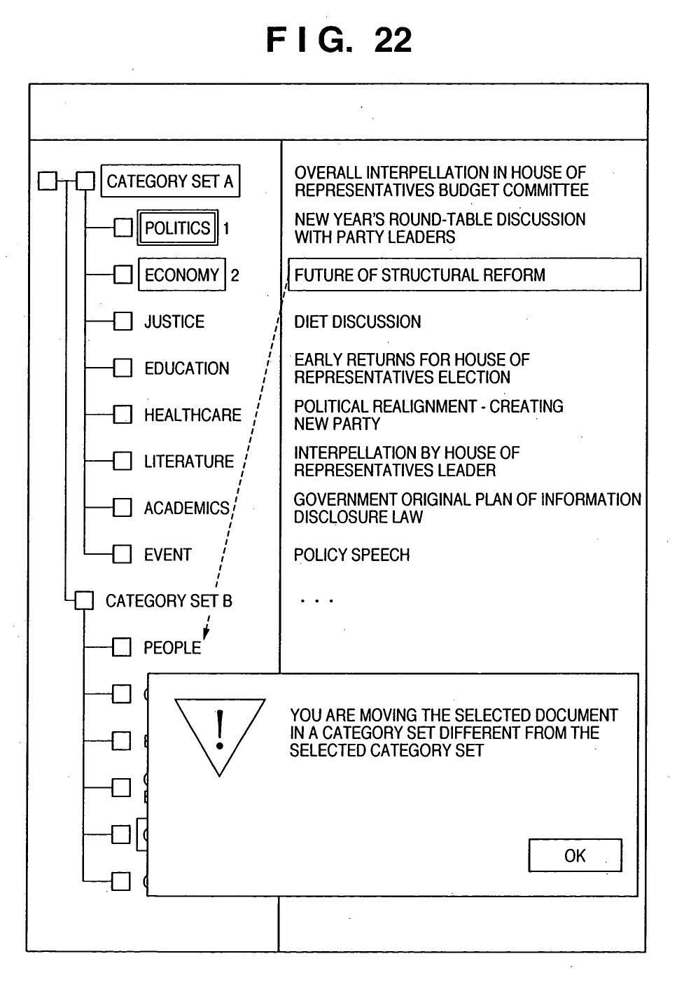

In the above-described second embodiment, the document of interest is dragged to the category “people” to realize document movement between categories in the category set B while the category of interest is fixed to the current category set A. In the third embodiment, when the document of interest is dragged to the category “people,” the category set of interest is switched to the category set B. An example is shown in FIG. 22.

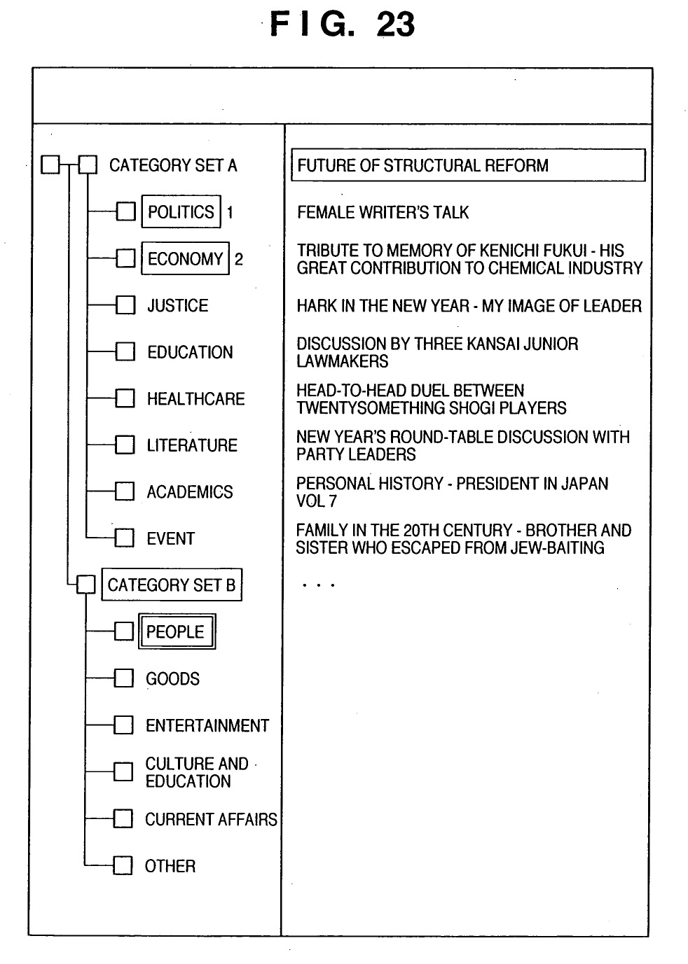

More specifically, when the category set of interest is the category set A and the category of interest is “politics” as shown in FIG. 22., if the document “future of structural reform” is dragged to the category “people” in the category set B, this movement of the document that occurs outside the category set of interest is confirmed by the user. As a result, the category set of interest is shifted to the category set B as shown in FIG. 23 and the category “people” becomes the category of interest. Among the group of documents in the category set B, a list of documents sorted into the category “people” is displayed in the right window. The selected document “future of structural reform” moved from the category “current affairs” to “people” by the above operation is shown on the top line of the list.

Note since the selected document is the document of interest, the indication of the categories “politics” and “economy” to which the document belongs in the category set A does not change. In other words, the sorting destination in the category set A does not change. Therefore, the categories “politics” and “economy” remain unchanged as the first and second priority ranks respectively.

### Fourth Embodiment

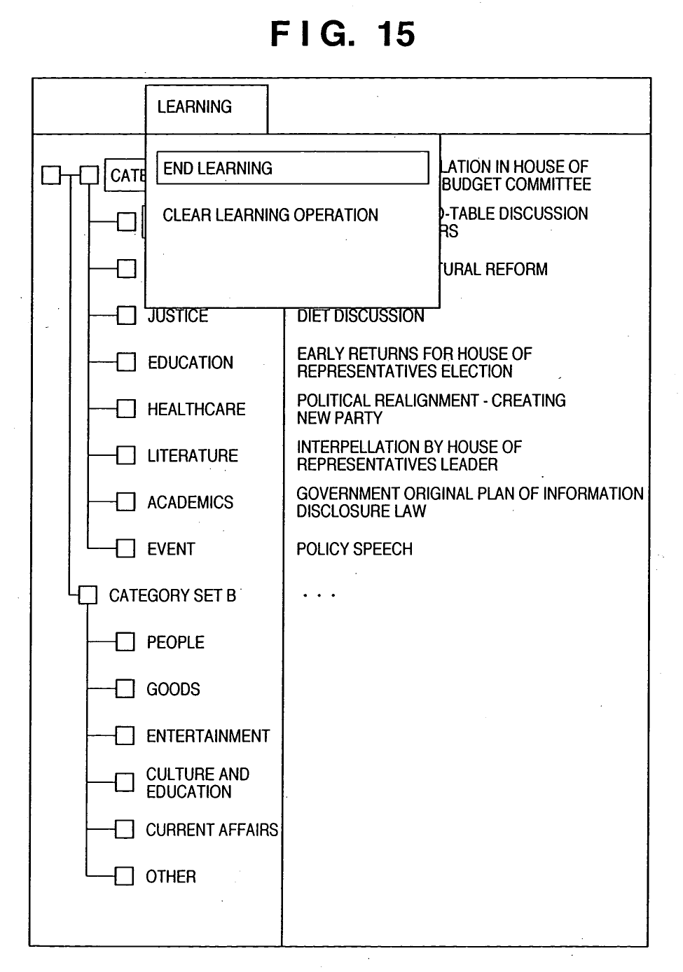

In the above-described embodiments, in a case where a document is moved between categories, the characteristic amount of the document is always controlled to perform system learning. However, the present invention is not limited to this. When a document is moved, a user may open the menu shown in FIG. 15 to select whether or not to reflect the result of document movement. “End learning” in FIG. 15 is selected when the user wants to start up the learning process in response to the document moving operation between categories, and reflect in the weight dictionary the change in the amount of weight calculated based on the change in sorting. “Clear learning operation” is selected when the user wants to invalidate all the document moving operation between categories performed so far and return to the original sorting state.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. A data sorting apparatus for sorting data into categories, comprising:
means for designating movement of data between categories; and
means for outputting a message in accordance with a category-belonging state of the data, in a case where data movement between categories is designated.

2. The data sorting apparatus according to claim 1, wherein in a case where a plurality of category sets are defined and data is moved to a category of a different category set, said means for outputting a message outputs a warning message.

3. The data sorting apparatus according to claim 1, wherein in a case where data subjected to moving belongs to one category, in response to data moving designation, said means for outputting a message outputs a confirmation message to confirm whether or not belongingness to the category the data has belonged should remain valid.

4. The data sorting apparatus according to claim 1, wherein in a case where data subjected to moving belongs to a plurality of categories, in response to moving designation to move data to a category the data has already belonged, said means for outputting a message outputs a confirmation message to confirm whether or not belongingness to other category should be invalidated.

5. The data sorting apparatus according to claim 1, wherein in a case where data subjected to moving belongs to a plurality of categories, in response to moving designation to move data to a category other than a category the data has already belonged, said means for outputting a message outputs a confirmation message to confirm whether or not belongingness to the category the data has already belonged should be validated.

6. The data sorting apparatus according to claim 1, wherein in a case where data subjected to moving belongs to a plurality of categories, in response to moving designation to move data to a category the data does not belong, said means for outputting a message outputs a message including an option regarding data belongingness.

7. The data sorting apparatus according to claim 3, further comprising:
means for sorting data into categories based on a characteristic amount of data and a characteristic amount of a category; and
means for controlling the characteristic amount of data and/or category based on a selection designated in response to the confirmation message.

8. The data sorting apparatus according to claim 4, further comprising:
means for sorting data into categories based on a characteristic amount of data and a characteristic amount of a category; and
means for controlling the characteristic amount of data and/or category based on a selection designated in response to the confirmation message.

9. The data sorting apparatus according to claim 5, further comprising:
means for sorting data into categories based on a characteristic amount of data and a characteristic amount of a category; and
means for controlling the characteristic amount of data and/or category based on a selection designated in response to the confirmation message.

10. The data sorting apparatus according to claim 6, further comprising:
means for sorting data into categories based on a characteristic amount of data and a characteristic amount of a category; and
means for controlling the characteristic amount of data and/or category based on a selection designated in response to the message including the option.

11. The data sorting apparatus according to claim 7, further comprising means for selecting whether or not to execute controlling of the characteristic amount in response to data movement.

12. The data sorting apparatus according to claim 8, further comprising means for selecting whether or not to execute controlling of the characteristic amount in response to data movement.

13. The data sorting apparatus according to claim 9, further comprising means for selecting whether or not to execute controlling of the characteristic amount in response to data movement.

14. The data sorting apparatus according to claim 10, further comprising means for selecting whether or not to execute controlling of the characteristic amount in response to data movement.

15. A data sorting method for sorting data into categories, comprising the steps of:
designating movement of data between categories; and
outputting a message in accordance with a category-belonging state of the data, in a case where data movement between categories is designated.

16. A computer-executable program comprising:
code for designating movement of data between categories; and
code for outputting a message in accordance with a category-belonging state of the data, in a case where data movement between categories is designated.
